(19) United States
(12) Patent Application Publication
(10) Pub. No.: US 2013/0294558 A1
(43) Pub. Date: Nov. 7, 2013

(54) FUSION REACTOR

(71) Applicant: David J. Schulte, Harbor Springs, MI (US)

(72) Inventor: David J. Schulte, Harbor Springs, MI (US)

(21) Appl. No.: 13/366,059

(22) Filed: Feb. 3, 2012

(51) Int. Cl. G21B 1/00

(52) U.S. Cl. 376/147

(57) ABSTRACT

The present invention provides a fusion reactor for generating electricity comprising a high-pressure core having an interior chamber. The interior chamber is filled with a volume of one or more pressurized fuels. A microwave frequency generator is provided for resonating the fuel at a high radio frequency, typically 2.4 GHz or higher, and means for securing and emitting the frequency generator into the core are provided. In addition, electrical conductors are positioned in the core to effectuate the transformation of the fuel into a plasma state and to facilitate the free flow of electrons to generate electrical current.

### BACKGROUND OF THE INVENTION

1. Field of the Invention

The present invention pertains to a fusion reactor for generating electricity. More particularly, the present invention pertains to a fusion reactor for generating electricity using nuclear fusion reactions.

2. Description of the Prior Art

Fusion is the process by which two light nuclei combine to form a heavier one. The fusion process releases a tremendous amount of energy in the form of fast moving particles. Because atomic nuclei are positively charged—due to the protons contained therein—there is a repulsive electrostatic, or Coulomb, force between them. For two nuclei to fuse, this repulsive barrier must be overcome, which occurs when two nuclei are brought close enough together where the short-range nuclear forces become strong enough to overcome the Coulomb force and fuse the nuclei. The energy necessary for the nuclei to overcome the Coulomb barrier is provided by their thermal energies, which must be very high.

For example, the fusion rate can be appreciable if the temperature is at least of the order of 10⁴ eV, which corresponds roughly to 100 million degrees Kelvin. The rate of a fusion reaction is a function of the temperature, and it is characterized by a quantity called reactivity.

Typical fusion reactions are classified into three different generations as follows:

First Generation Fusion Reactions

D+D→³He(0.82 MeV)+n(2.45 MeV)→p(3.02 MeV)+T(1.01 MeV)

D+T→⁴He(3.52 MeV)+n(14.07 MeV)

Second Generation Fusion Reaction

D+³He→⁴He(3.67 MeV)+p(14.68 MeV)

Third Generation Fusion Reactions

p+¹¹B→3⁴He(8.7 MeV)

³He+³He→⁴He+p(12.9 MeV)

In the reactions above, D indicates deuterium, T indicates tritium, n indicates a neutron, p indicates a proton, ³He indicates Helium-3, ⁴He indicates helium, and ¹¹B indicates Boron-11. The numbers in parentheses in each equation indicate the kinetic energy of the fusion products.

The first generation reactions listed above—the D-D and D-T reactions—are neutronic, which means that most of the energy of their fusion products is carried by fast neutrons. The disadvantages of neutronic reactions are that: (1) the flux of fast neutrons creates many problems, including structural damage of the reactor walls and high levels of radioactivity for most construction materials; and (2) the energy of fast neutrons is collected by converting their thermal energy to electric energy, which is very inefficient (less than 30%). The advantages of neutronic reactions are that: (1) their reactivity peaks at a relatively low temperature; and (2) their losses due to radiation are relatively low because the atomic numbers of deuterium and tritium are 1.

The reactants in the other equations—D-³He, p-¹¹B, and ³He—³He—are called advanced fuels. Instead of producing fast neutrons, as in the neutronic reactions, their fusion products are charged particles. One advantage of the advanced fuels is that they create much fewer neutrons and therefore suffer less from the disadvantages associated with them. In the case of D-³He, some fast neutrons are produced by secondary reactions, but these neutrons account for only about 10 percent of the energy of the fusion products. The p-¹¹B reaction is free of fast neutrons, although it does produce some slow neutrons that result from secondary reactions but create much fewer problems.

The ³He—³He reaction does not produce any fast or slow moving neutrons, and is therefore a truly radiation-free nuclear reaction. Another advantage of the advanced fuels is that their fusion products comprise charged particles whose kinetic energy may be directly convertible to electricity. With an appropriate direct energy conversion process, the energy of advanced fuel fusion products may be collected with a high efficiency, possibly in excess of 90 percent.

However, the advanced fuels also have some disadvantages. For example, the atomic numbers of the advanced fuels are higher (2 for ³He and 5 for ¹¹B). Therefore, their radiation losses (Bremsstrahlung) are greater than in the neutronic reactions. Also, it is much more difficult to cause the advanced fuels to fuse. Their peak reactivities occur at much higher temperatures and do not reach as high as the reactivity for D-T. Causing a fusion reaction with the advanced fuels thus requires that they be brought to a higher energy state where their reactivity is significant. Accordingly, the advanced fuels must be contained for a longer time period wherein they can be brought to appropriate fusion conditions.

The ³He—³He reaction requires even higher temperatures than the D-³He reaction, and is thus even more difficult to obtain. However, the ³He—³He reaction offers a possible reaction that produces no neutrons in the form of radiation. The protons produced by this reaction possess charges that can be contained using electric and magnetic fields, which in turn result in direct electricity generation.

The amounts of ³He fuel that would be required are also beyond the volume currently available. While ³He is scarce on earth, the moon is known to have ample amounts of ³He which it has received from the sun in the form of solar wind. The earth's atmosphere deflects the ³He, and therefore the only ³He on earth is that left from the formation of the planet, and that formed as a reaction product from the other fusion reactions above. This has lead to speculation and theories of mining the moon for ³He in the future. If ³He—³He reactors are sufficiently perfected, the economics may be justified in doing so because it is believed that only a small number of mining trips would be necessary each year to retrieve sufficient amounts of ³He to alleviate our energy demands. Although this may sound like science fiction by today's standards, less than sixty years elapsed between the Wright brothers' first flight and the first landing on the moon by an unmanned craft.

Referring back to fusion reactions in general, the containment time for a plasma is Δt=r²/D, where r is a minimum plasma dimension and D is a diffusion coefficient. The classical value of the diffusion coefficient is D_{c}=aᵢ²/τᵢₑ, where aᵢ is the ion gyroradius and τᵢₑ is the ion-electron collision time. Diffusion according to the classical diffusion coefficient is called classical transport. The Bohm diffusion coefficient, attributed to short-wavelength instabilities, is D_{B}=(1/16)aᵢ² Ωᵢ, where Ωᵢ is the ion gyrofrequency. Diffusion according to this relationship is called anomalous transport. For fusion conditions, D_{B}/D_{C}=(1/16)Ωᵢ τᵢₑ≅10⁸, anomalous transport results in a much shorter containment time than classical transport. This relation determines how large a plasma must be in a fusion reactor, by the requirement that the containment time for a given amount of plasma must be longer than the time for the plasma to have a nuclear fusion reaction. Therefore, classical transport condition is more desirable in a fusion reactor, allowing for smaller initial plasmas.

For a nuclear fusion reactor to produce energy, it is necessary for the plasma to be thermally insulated from the surrounding area for a sufficient period of time that the Lawson criterion is satisfied. The Lawson criterion is generally expressed in the form of the equation n*t≧1.5*10²⁰ sec/m³ for a Deuterium-Tritium reaction, where n is the particle density and t is the confinement time of the plasma.

Generally speaking, the confinement of the plasma has taken two different types of approaches, one of which is magnetic confinement which relies on the magnetic field to reduce the thermal transport, while the other approach relies upon the inertial confinement of the particles in a vacuum. There have also been several methods that use a gas for providing thermal insulation. In these proposed methods, the particles are not confined, but the thermal conductivity of electrons is to be reduced by applying a modest magnetic field. For a plasma in which the heat is confined but not the pressure, the required temperature for breakeven is higher than the case of pressure-confined plasmas because of the increased Bremsstrahlung loss. With a parabolic temperature profile, the required temperature is about three times higher.

In early experiments with toroidal confinement of plasma, a containment time of Δt≅r²/D_{B} was observed. Progress in the last 40 years has increased the containment time to Δt≅1000 r²/D_{B}. One existing fusion reactor concept is the Tokamak. For the past 30 years, fusion efforts focused on the Tokamak reactor have been using D-T fuel. These efforts have culminated in the International Thermonuclear Experimental Reactor (ITER). Recent experiments with the Tokamak suggest that classical transport, Δt≅r²/D_{c}, is possible, in which case the minimum plasma dimension can be reduced from meters to centimeters. These experiments involved the injection of energetic beams (50 to 100 keV) to heat the plasma to temperatures of 10 to 30 keV. See W. Heidbrink & G. J. Sadler, 34 Nuclear Fusion 535 (1994). The energetic beam ions in these experiments were observed to slow down and diffuse classically while the thermal plasma continued to diffuse anomalously fast. The reason for this is that the energetic beam ions have a large gyroradius and, as such, are insensitive to fluctuations with wavelengths shorter than the ion gyroradius (λ<aᵢ). The short-wavelength fluctuations tend to average over a cycle and thus cancel. Electrons, however, have a much smaller gyroradius, so they respond to the fluctuations and transport anomalously.

Because of anomalous transport, the minimum dimension of the plasma must be at least 2.8 meters in the Tokamak. Due to this dimension, the ITER is 30 meters high and 30 meters in diameter. This is the smallest D-T Tokamak-type reactor that is feasible. For advanced fuels, such as D-³He, p-¹¹B, and ³He—³He, the geometry of a Tokamak-type reactor would have to be much larger because the time for a fuel ion to have a nuclear reaction is much longer. A Tokamak reactor using D-T fuel has the additional problem that most of the energy of the fusion products energy is carried by 14 MeV neutrons, which cause radiation damage and induce reactivity in almost all construction materials due to the neutron flux. In addition, the conversion of their energy into electricity must be by a thermal process, which is not more than 30% efficient.

Other ongoing attempts to create and harness ³He—³He reactions use LASERs to attempt to achieve the extreme temperatures required. However, a LASER can only raise the temperature to a given limit based upon factors like the power, or intensity, of the light. LASER is a form of light, and thus does not convert or dissipate to kinetic energy. Although LASERs product heat, it is not nearly enough to initiate a fusion reaction using any currently-known types of LASERs.

It is believed that in order to have high heat, one must create or cause very high electron vibration in the mass being heated. Vibration is kinetic energy—not heat. The heat is merely a byproduct of the molecular excitation. LASERs do not create high electron vibration, and therefore, past and present attempts to create fusion using LASERs are believed to be fundamentally flawed. In the microwave-based fusion reactor described below, testing has consistently achieved very localized extreme levels of heat within the dense plasma sufficient to vaporize (requiring temperatures far beyond boiling or melting) tungsten metal within 5 seconds with as little as 500 Watts of AC power from a typical wall outlet. These results are unprecedented, as tungsten has one of the highest melting and boiling points of any metal on the periodic table. It is believed that no other scientist or fusion researcher has been able to achieve these temperatures, let alone in 5 seconds using just 500 Watts. When the tungsten vaporizes in the chamber, an incredibly bright constant ongoing display of the whitest brightest form of light is produced. Alpha particles, neutrons, x-rays, gamma rays, and electrons are all released in an incredibly bright display. By tapping into the natural frequency of the molecules, it is possible to raise the temperature as high as needed.

Thus, it is apparent that the Applicant has developed an improved nuclear reactor.

The present invention, as is detailed hereinbelow, seeks to provide a new nuclear reactor for generating electricity fueled at least in part by inert gases.

### SUMMARY OF THE INVENTION

According to the preferred embodiment hereof, the present invention provides a nuclear reactor for generating electricity comprising: (a) a core having a substantially spherical interior chamber, the interior chamber having a top portion, a bottom portion, and the core being filled with a volume of a fuel; (b) a frequency generator secured to the core and configured to input a signal into the interior chamber to resonate the fuel at a high frequency; (c) a pair of electrical conductors, the first electrical conductor from the pair of electrical conductors connected to the top portion, and the second electrical conductor from the pair of electrical conductors connected to the bottom portion, the pair of electrical conductors provided to conduct the flow of electricity away from the core; and (d) a plurality of conductive electron receivers connected to each of the first and second electrical conductors, the plurality of electron receivers extending at least partially into the interior chamber.

In a particular embodiment described below, the fuel comprises known nuclear fuel sources, such as Boron-11 (¹¹B), deuterium, tritium, or Helium-3 (³He). The fuel can also comprise any inert, or noble, gas. More preferably, the gas comprises an inert gas. Even more preferably, the gas comprises ³He. As described in the reaction above, in a ³He—³He fusion reaction, the byproducts are 4He and a proton which can be contained using electric and magnetic fields to directly produce electricity.

The core of the reactor can optionally include an outer corrosive layer which may comprise any suitable material which has both anti-corrosive properties and can withstand high temperatures, such as lithium. A coolant, such as water, can also optionally be circulated over the outer layer and heated into steam which is then used to generate turbines to create electricity.

For a more complete understanding of the present invention, reference is made to the following detailed description and accompanying drawing. In the drawing, like reference characters refer to like parts throughout the views in which:

### BRIEF DESCRIPTION OF THE DRAWING

FIG. 1 is a cross-sectional view of a first embodiment of the present invention hereof;

FIG. 2 is an enlarged cross-sectional view of a waveguide and the means for attaching the frequency generator to the core;

FIG. 3 is an enlarged cross-sectional view showing an embodiment of the plurality of electron receivers disposed on the interior chamber lining;

FIGS. 4 and 5 are cross-sectional views showing an embodiment including an enlarged second core for housing and protecting the core;

FIG. 6 shows an embodiment including means for isolating the fusion reactor from vibration;

FIG. 7 shows the core comprising separate halves which are secured together via coupling threads capable of containing an internal pressure up to 5,000 psi, the core in this embodiment preferably having at least one-half inch thick walls made from solid brass and forming an interior with very little gap between the halves to provide a very smooth interior;

FIG. 8 shows a half of the core including a valve stem assembly threadably secured to the core in which the valve stem assembly does not protrude into the interior of the core, and is capable of withstanding and containing pressures up to 5,000 psi within the core;

FIG. 9 shows an exemplary embodiment of the core having an internal diameter equal to the ten thousandths decimal place of π, that is, 3.1415″, and having a smooth inside surface which is preferably polished to a shine;

FIG. 10 show an exemplary half of the core including a plurality of holes (8 shown) staggered through the wall of the half-sphere, each hole being electrically insulated from the sphere with Teflon®, nylon, or a similar insulator to electrically and thermally separate the metallic wire passing therethrough from the brass sphere; and

FIG. 11 shows an exemplary core including an access window for delivering an RF signal into the core.

### DETAILED DESCRIPTION OF THE PREFERRED EMBODIMENT

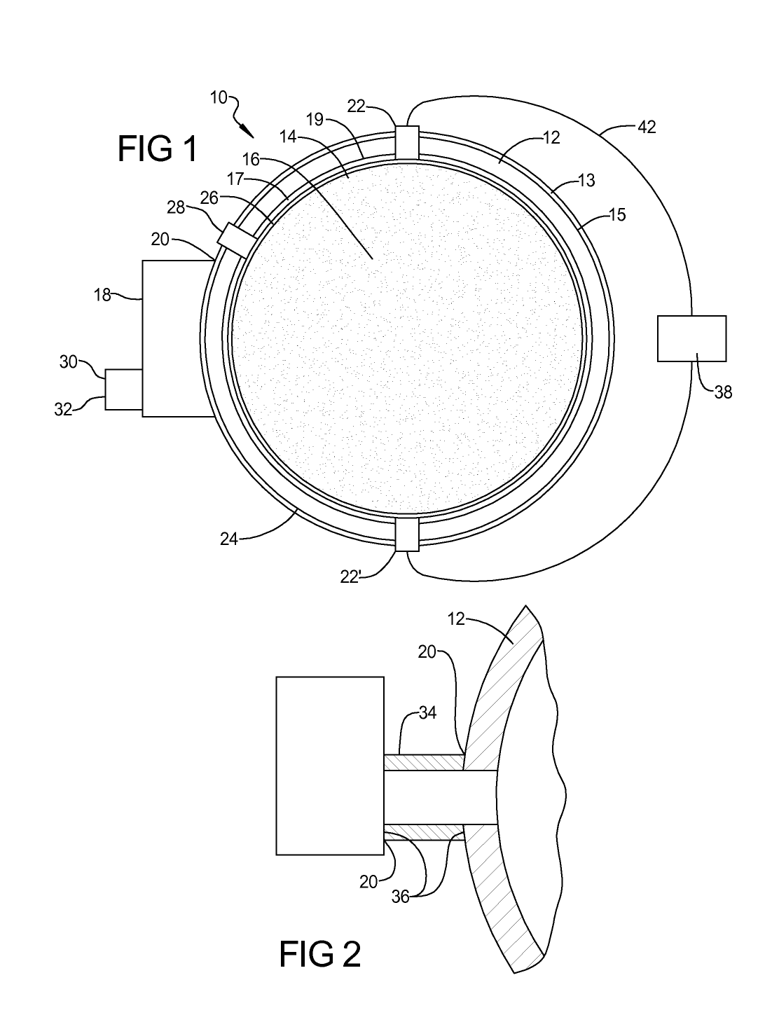

In accordance with a first embodiment of the present invention and as shown generally in FIG. 1, there is provided a reactor 10 for generating electricity comprising a core 12 having an interior chamber 14 which is filled with a volume of a fuel 16, a frequency generator 18 secured to the core 12, the frequency generator 18 provided to resonate the fuel 16 at a high frequency, and a pair of electrical conductors 22, 22′ connected to the core 12 for conducting the generated electricity away from the core 12.

The core 12 includes the interior chamber 14 and an exterior surface 24. Although the interior chamber 14 can be any suitable shape so long as the fuel 16 can achieve Lawson's criterion, it is most preferably spherical in order to achieve a “standing wave resonance” within the fuel 16.

A spherical configuration is preferred because it will effectuate the “standing wave resonance” within the fuel 16 in the interior 14 of the sphere, unlike a box, or torus, all of which will lead to harmonic breakdown. The exterior 24 of the core 12 can also be shaped to match the interior chamber 14.

The core 12 comprises any suitable material which can contain the resonating fuel 16 therein, and which is beneficial to the flow of electrons from the resonating fuel 16 to the electrical conductors 22, 22′, as discussed further below. Preferably, the core 12 is comprised of any suitable material having a high melting point, a high temperature stability, a low coefficient of thermal expansion, and anti-corrosive properties. More preferably, the core 12 is formed from a metal. Even more preferably, the core 12 is formed from beryllium or a beryllium alloy. Although beryllium is diamagnetic, the core 12 can optionally and alternatively comprise a magnetic material.

In addition, when the nuclear reaction is neutronic, beryllium is desirable as a material because it can trap neutronic particles released during the fusion process and prevent them from escaping the core 12. Thus, beryllium has properties which—to a certain degree—resist the objects outside the core 12 and the fusion reactor from becoming radioactive over time.

In this regard, and as shown in FIG. 7, the core 12 can comprise two separate half-spheres which can be hermetically sealed together using suitable means such as being bolted together, being threadably sealed together 9, or the like.

Optionally, the core 12 can have an inner surface which is polished to a mirror finish. Such a finish can facilitate achieving a standing wave resonance of the fuel 16.

Optionally, the core 12 can include an outer corrosive layer 13 on the exterior surface 15, and an inner corrosive layer 17 on the interior surface 19 of the core 12 to absorb neutrons, to trap or reflect Alpha particles, to withstand high temperatures, and to protect the integrity of the core 12 itself. The inner corrosive layer 17 is preferably formed from an anti-corrosive material, such as Lithium 7. The outer corrosive layer 13 can comprise zinc chromate or any other suitable high-temperature corrosion-proof coating. The inner layer 17 and the outer layer 13 can each comprise any suitable neutron-absorbing and Alpha-particle absorbing materials as described hereinbelow. In addition, each of the layers 13 and 17 can optionally comprise beryllium or carbon fiber.

The size of the core 12 can be any dimension which is suitable for use with a particular embodiment (as discussed further below). However, when the interior chamber 14 is a sphere, then the radius is preferably an even-numbered divisible of π (i.e., 3.14159265 . . . ) or Φ (i.e., 1.6180339 . . . ), or a close approximation thereof. The size of the core 12 as used in various applications is discussed further below.

The interior chamber 14 of the core 12 is optionally covered with a lining 26 to facilitate the flow of electrons to the electrical conductors 22, 22′. When provided, the lining 26 can comprise any suitable material which will withstand high temperatures and preferably create an electrical potential difference with the electron receivers 40. Optionally, the lining 26 can comprise a conductive silicon which can function like a solar panel to collect electrical charge. As described in further detail below, the electron receivers 40 can be embedded into the lining 26 to facilitate improved production of plasma via lightning about the ends of the electron receivers 40 which additionally serve to collect the free electrons released by the fusion reaction.

The lining 26 can also operate like a capacitive conductor. For instance, the lining 26 can hold an electric charge, and then release that charge to a conductive material once it has reached a supersaturated state. Accordingly, the lining 26 can comprise a material such as a fluoropolymer sold under the trademark Teflon®, a polyimide film sold under the trademark Kapton®, or like materials having similar conduction and heat-resistance properties. The lining 26 can also comprise materials such as glass, mirrored glass, vanadium, beryllium, carbon fiber, or the like.

The lining 26 can also optionally comprise a material which is neutron-absorbing and/or Alpha-particle absorbing and can be disposed on the interior and/or exterior surfaces of the core 12. Any suitable materials which are well-known in the art as having neutron-absorbing properties can be used, including but not limited to, the boron-inclusive neutron-absorbing materials sold under the marks Boral®, Bortec® MMC, BorAluminum™ Alloy, and BoroBond®, or any other suitable materials, such as any which are approved by the Department of Energy as being neutron-absorbing materials.

The interior chamber 14 can also optionally include means for magnetically confining the plasma. The means for magnetic confinement can include either electromagnetic or stationary magnetic coils to confine the plasma.

The core 12 can optionally include a sealed entry 28 for accessing the interior chamber 14 for both inserting the fuel 16 and for removing reaction byproducts. The entry 28 can comprise a hinged locking door which is properly insulated, a removable panel, an injection valving system, a pierceable gasket, or any other suitable entry for introducing fuel 16 into the interior chamber 14 and removing any byproducts as necessary. When the entry 28 is a pierceable gasket, the fuel 16 can be introduced into the interior chamber 14 by injecting it using a needle or similar means.

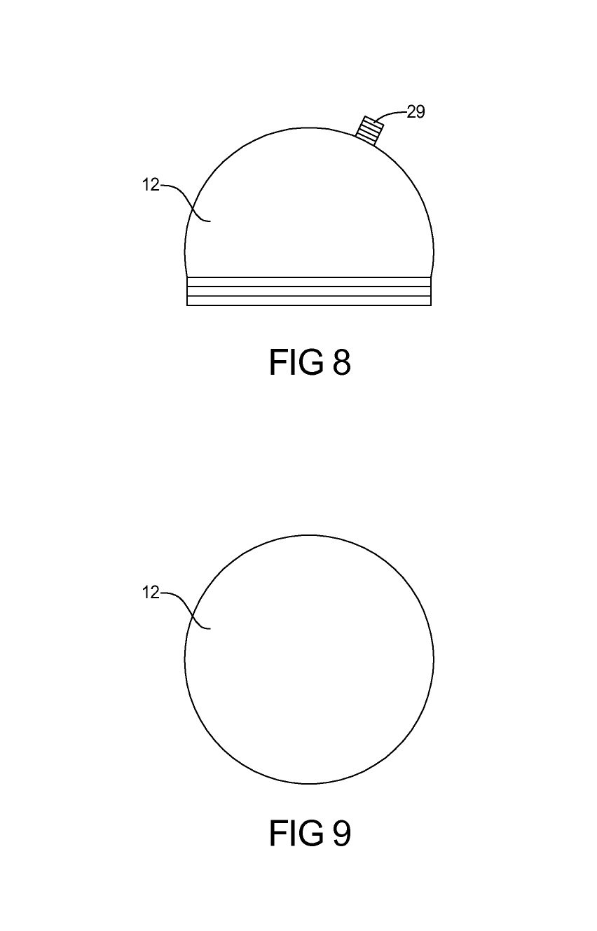

For purposes which will be discussed in further detail below, the interior chamber 14 is filled with a volume of the fuel 16. The fuel 16 is preferably pressurized at a pressure greater than atmospheric pressure. Even more preferably, the fuel 16 is pressurized up to 5,000 psi, with a preferred operating pressure that can be around 2,000-2,500 psi, although that can depend upon factors like the fuel used and the size of the core 12. Although any suitable fuel mentioned above can be used, the fuel 16 preferably comprises an inert gas. Even more preferably, the fuel 16 comprises ³He. The fuel 16 is introduced into the core 12 either during assembly of the reactor 10, or via the sealed entry 28, if provided, while the reactor 10 is not in use. Optionally, the reactor 10 can be plumbed with gas lines (not shown) to continuously (or periodically) pump fuel 16 into the core 12 and/or flush out reaction byproducts. Before filling the interior chamber 14 with the fuel 16, all air can be removed from the interior chamber 14 to create a vacuum. The interior chamber 14 can then be filled with the fuel 16. As shown in FIG. 8, to facilitate with filling, emptying, and vacuuming out all of the air and fuel contents, the core 12 can include a valve stem assembly 29 in fluid communication with the interior chamber 14. The valve stem assembly 29 includes a threaded connection, nozzle, or other suitable structure for connection with a tank or hose for eliminating air from, or delivering fuel 16 to, the interior chamber 14. Preferably the valve stem assembly 29 is the same as or similar to the type known for use with automobiles.

The reactor 10 also includes a frequency generator 18 for resonating the fuel 16 at a high frequency. The frequency generator 18 resonates the fuel 16 molecules at an amplitude and frequency sufficient to resonate the fuel 16 molecules at a single peak intensity, or a “standing wave resonance.” The frequency generator 18 is any suitable type of frequency generator known in the art, such as a traveling-wave tube, a magnetron, a gyrotron, a klystron, or the like. Preferably, the frequency generator 18 is capable of outputting consistently in a narrow band of radio frequency or microwave frequency electromagnetic wavelength regions to resonate the fuel 16. In some embodiments, the frequency generator 18 may be pulsed ON and OFF at a high rate, for instance, 10-400 cycles per second. The type of frequency generator used will be dictated, in part, by the size of the reactor 10 deployed for any particular application. In order to sufficiently resonate the fuel 16 to create the standing wave resonance, the frequency generator 18 can produce a frequency which is equal to, or a multiple of the natural frequency of the fuel 16 molecules. The frequency generator 18 is attached to the reactor 10 as described in detail hereinbelow.

As shown in FIG. 11, at least one access window 21 can optionally be provided to either view the interior chamber 14 or to allow the signal provided by the frequency generator 18 to pass therethrough. When provided, the access window 21 must be dimensioned and secured to the core 12 so that the interior chamber 14 remains hermetically sealed. The access window 21 can comprise any suitable material which allows the signal to pass therethrough, such as a ceramic panel, a glass window, a transparent panel formed from a material such as a polycarbonate resin thermoplastic sold under the trademark Lexan®, or the like. Preferably, the access window 21 is inserted from the inside of the core 12, and is precisely engineered and manufactured perfectly seal against the interior wall of the core 12. Gaskets can be provided as necessary between the access window 21 and the core 12 to ensure that the interior chamber 42 remains pressurized.

A power source 30 for operating the frequency generator 18 is also provided. The power source 30 can be a DC battery, an AC outlet, or the like. In addition, the reactor 10 itself can provide the power necessary to operate the frequency generator 18, so long as an auxiliary power source (not shown), such as a battery, is provided to initially power the frequency generator 18 until the reactor 10 has produced sufficient electricity to become self-operational. The power source 30 can be connected to the frequency generator 18 by an electrical circuit, such as a switch 32, to allow the reactor 10 to be turned on or off.

As shown in FIG. 2, the present invention can also include a waveguide 34 for directing the extracted RF energy from the frequency generator 18 to the interior chamber 14 of the reactor 10. The waveguide 34 is a structure which guides a wave, such as an electromagnetic wave. The waveguide 34 can be formed from a material, such as cast brass or bronze, which is typically used for microwave oven apertures. The waveguide 34 is tuned for exact dimension based upon the frequency of the RF wavelength emitted. It is preferably rectangular in cross-section, however a round TWT traveling wave tube emission can also be employed. It is also noted that the waveguide 34 is not required, as the frequency generator 18 can emit electromagnetic waves directly into the core 12 of the interior chamber 14.

When a waveguide 34 is provided, means for securing 20 can be provided to attach the waveguide 34 to both the frequency generator 18 and the core 12. The means for securing 20 includes fasteners such as bolts, welding, or the like.

The core 12, frequency generator 18, and waveguide 34 are hermetically sealed together in order to contain the pressurized fuel 16. A plurality of gaskets 36 suited for high pressure applications is provided to ensure that the fuel 16 remains pressurized within the interior chamber 14 of the core 12. At least one gasket from the plurality of gaskets 36 is provided as required between each of the core 12 and the waveguide 34, as well as between the waveguide 34 and the frequency generator 18. When the core 12 comprises separate half-spheres, at least one gasket from the plurality of gaskets 36 is provided to provide a hermetic seal between the halves.

It is to be appreciated by one having ordinary skill in the art that the fuel 16 may not escape while under pressure and that the plurality of gaskets 36 is provided because the pressurized fuel 16 must be properly contained within the reactor 10. Each of the gaskets in the plurality of gaskets 36 is formed from any suitable type of material known in the art for providing a hermetic seal, such as an elastomer.

Lightning within a microwave oven is a phenomena witnessed by most people when a metallic object, such as a spoon or fork, is accidentally placed within the microwave. During operation of the microwave, lightning and arcing are created about the metallic object. Likewise, in use, the frequency generator 18 resonates the fuel 16 molecules to a resonant standing wave.

As understood by one having ordinary skill in the art, the Lawson criterion is measured by the plasma density multiplied by the energy confinement time given a certain temperature. Once this number is achieved, the fusion reactions release the same amount of energy that was used to start the reactions, also known as the breakeven or ignition. “Ignition” occurs when the reactor releases enough energy to sustain itself, despite the loss of heat through radiation and conduction. After surpassing the Lawson criterion, the fuel 16 turns into a plasma state having high surface tension and high surface temperatures to fuse nuclei together and strip the atoms of electrons, thereby allowing the fuel 16 molecules' electrons to become free flowing within the plasma.

The reactor 10 also includes a pair of electrical conductors 22, 22′ for conducting the free electrons from the interior chamber 14 to an output 38. Preferably the electrical conductors 22, 22′ are spaced apart and opposed from each other, and have opposite polarity to each other. Three or more electron conductors can optionally be provided as well.

As such, the free electrons in the resonating fuel 16 are naturally attracted to the oppositely-charged electrical conductor, 22 or 22′, thereby facilitating the flow of electricity as described further below. Each of the electrical conductors 22, 22′ have both a structure and a material-type which can conduct electricity from the interior chamber 14 to the exterior 24 of the core 12. For example, the conductors 22, 22′ can be directly embedded and attached to the lining 26. Optionally, the electrical conductors 22, 22′ can comprise rods extending from the interior chamber 14 to the exterior 24 of the core 12. Preferably the rods comprise a non-metallic material, such as graphite or carbon. Any type of material which can conduct electricity and operate at high-temperatures is suitable for use as an electrical conductor.

Alternatively, rather than the pair of electrical conductors 22, 22′ (or in addition thereto), magnetic, or inductive, pickup coils (not shown) can be provided to conduct the free electrons from the interior chamber 14 to the output 38. The inductive pickup coil can be any suitable type, such as a permanent magnet wrapped in a conductive coil. The inductive pickup coil can be embedded in a conductive coil and secured on the outside of the coil and/or within the core 12, such that electricity is conducted to and/or generated in the inductive pickup coil when the fuel reaches a standing wave resonance within the core 12.

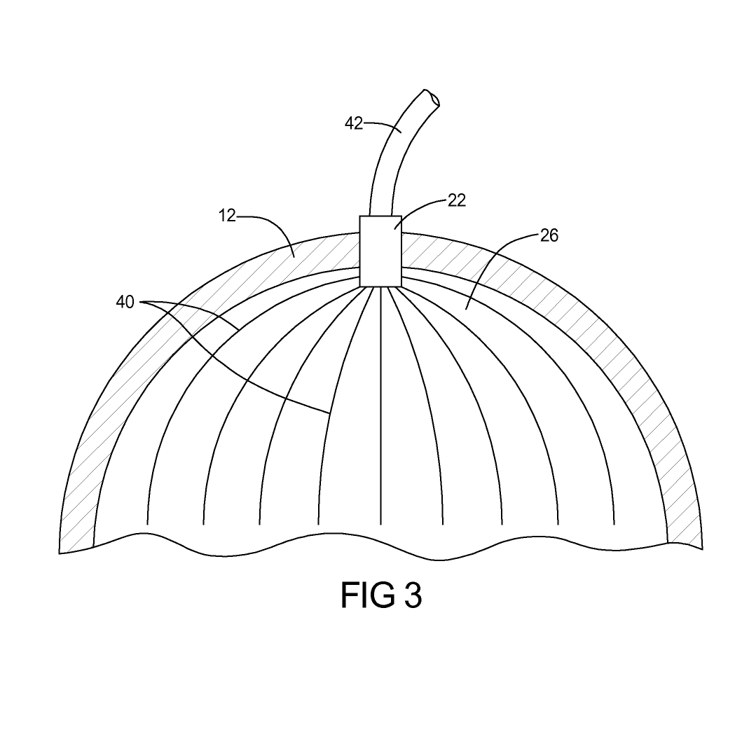

As shown in FIG. 3, a plurality of electron receivers 40 can be provided to attract and conduct the free electrons from the resonating fuel 16 to at least one of the electrical conductors 22 or 22′ to further aid in the flow of electricity. The plurality of electron receivers 40 can be in electrical connection with at least one of the electrical conductors, 22 or 22′, for the purpose of attracting free electrons from the resonating fuel 16 and conducting those electrons to a respective one of the electrical conductors, 22 or 22′. The plurality of electron receivers 40 comprises conductive materials which are suitable for high-temperature applications, such as carbon fiber, beryllium-copper, iridium, silicon, or the like. Preferably the plurality of electron receivers 40 comprises tungsten. It is understood by one having ordinary skill in the art that the type of material chosen will be affected by factors such as the operating temperatures reached within the interior chamber 14 for the particular application.

The plurality of electron receivers 40 can be an array of conductive wires (which can optionally be frayed), a conductive film, web, matrix, and so forth which assists in attracting and conducting the free electrons from the plasma to at least one of the electrical conductors 22 or 22′. The plurality of electron receivers 40 can be oriented to penetrate from the outside of the core 12 into the interior chamber 14 to effectuate lightning and arcing on a tiny but widespread scale over the entire inner surface of the spherical core 12. This activity will strip electrons out of the plasma created by microwave standing wave resonance acting upon the exposed electron receivers, or wiring, inside the spherical core 12.

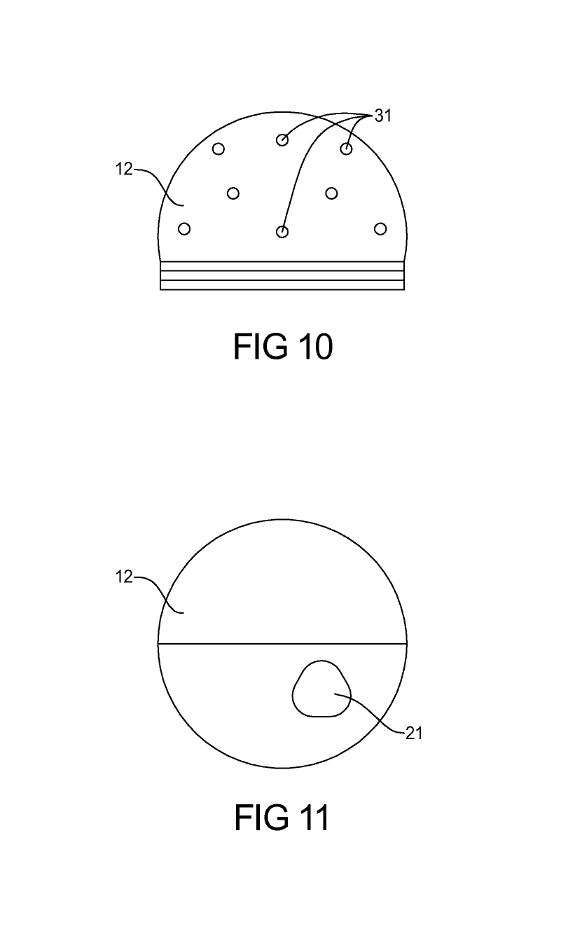

As shown in FIG. 10, each electron receiver from the plurality of electron receivers 40 can extend through a respective hole from a plurality of holes 31 (8 shown) staggered through the wall of the half-sphere, each hole being electrically insulated from the core 12 with Teflon®, nylon, or a similar insulator to electrically and thermally separate the respective metallic conductive wire electron receiver passing therethrough from the core 12.

Preferably, each of the receivers in the plurality of electron receivers 40 is formed from a conductive material which is resistant to very high temperatures, such as a metal. Any suitable metal having a high melting point can be used, such as tungsten. Each of the receivers can comprise a wire (either extending away from the core 12 and into the interior chamber 14 or being positioned along the interior wall of the core 12) having any suitable shape. For instance, each of the receivers can comprise “tungsten ribbon,” as understood by one having ordinary skill in the art. The electron receivers each form an electrode that are secured to the wall of the interior chamber 14 for the purpose of providing a low electrical resistance pathway for free protons and free electrons to exit the plasma and interior chamber 14 to charge an output 38 (described further below) such as a battery or a capacitor bank directly through a directional diode array or an ultra-fast diamond micro switch relay or the like. Preferably about eleven electron receivers are provided, although this can vary depending upon performance and capacity (size) of the specific embodiment.

When the reactor 10 is for particularly small applications, the plurality of electron receivers 40 can comprise only a small number of wire strands or ribbons protruding into the interior chamber 14. The plurality of electron receivers 40 can be imbedded within, or disposed on, the lining 26 on the interior chamber 14, such as found on a solar panel, and having the ends of each electron receiver being exposed to conduct electricity. Furthermore, the plurality of electron receivers 40 can have portions which are exposed to the resonating fuel 16 to attract free electrons, or any other configuration which will serve the purpose thereof. During use, the resonating fuel 16 will turn into a plasma, and the free elections will cause electrical current to arc between the electron receivers 40 which are in connection with the respective electrical conductors 22, 22′. In this regard, the plasma will provide an electrical pathway for the electrons to flow through the reactor 10.

The electrical conductors 22, 22′ conduct electricity to the output 38, such as a DC battery, a step-up transformer, or any other suitable type of electrical receiver which is used for storing, converting, and/or transmitting electrical current. The output 38 is connected to at least one of the electrical conductors, 22 or 22′, by any suitable means for conducting 42 which is well know in the art, such as insulated copper wiring.

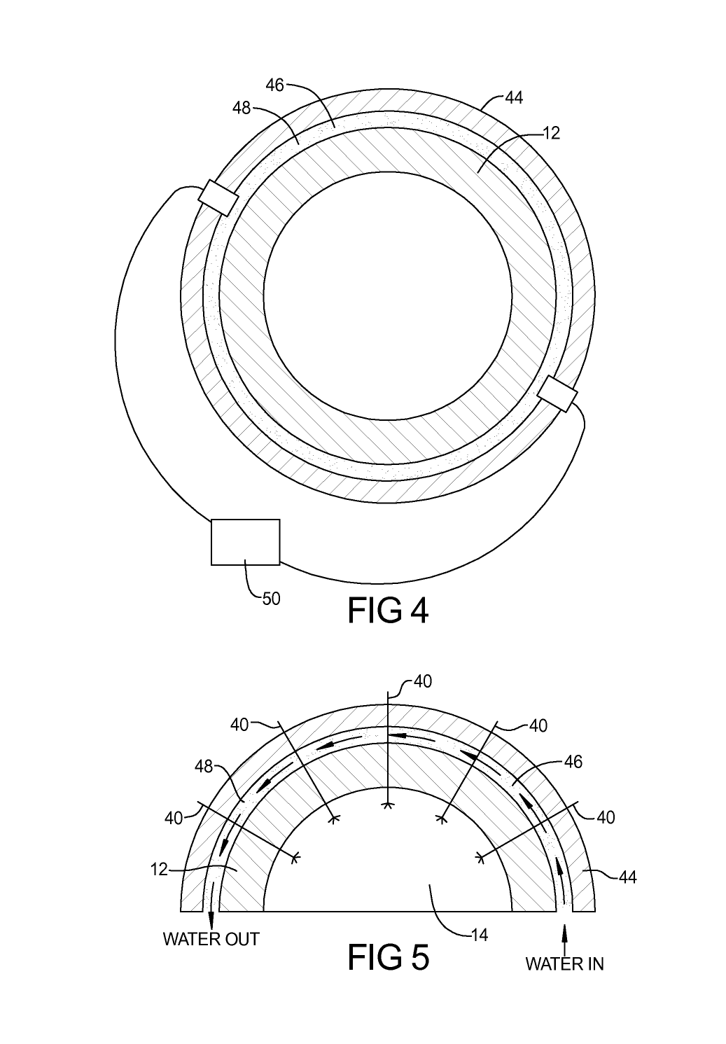

As shown in FIGS. 4 and 5, optionally an enlarged outer core 44 having an enlarged interior chamber 46 can be provided to contain the core 12. The interior chamber 46 is large enough to house the core 12, and is provided to assist in either cooling or insulating the core 12 during use. The outer core 44 is also provided for additional shielding and protection to the core 12. The outer core 44 is preferably formed from a high temperature non-radioactive material, such as coated beryllium, anodized beryllium, or aluminum-coated beryllium. When used for cooling, the interior chamber 46 can contain a coolant fluid 48, such as water, for circulation through the interior chamber 46 and around the core 12 to remove heat therefrom. The coolant fluid 48 is preferably one which is good at trapping neutrons, or Alpha particles. Thus, the outer core 44 can also comprise means for cooling and circulating 50 the coolant, which can include piping, pumps, means for cooling, and any other suitable elements for circulating cooled coolant fluid 48 through the interior chamber 46. The means for cooling can comprise a refrigeration unit, a radiator, a cooling pond, and so forth.

It is also contemplated that the present invention can be used in a manner to purposefully heat a fluid (e.g., water) passing over the core 12 for the purpose of creating steam to drive a turbine (not shown), and thus produce additional electricity.

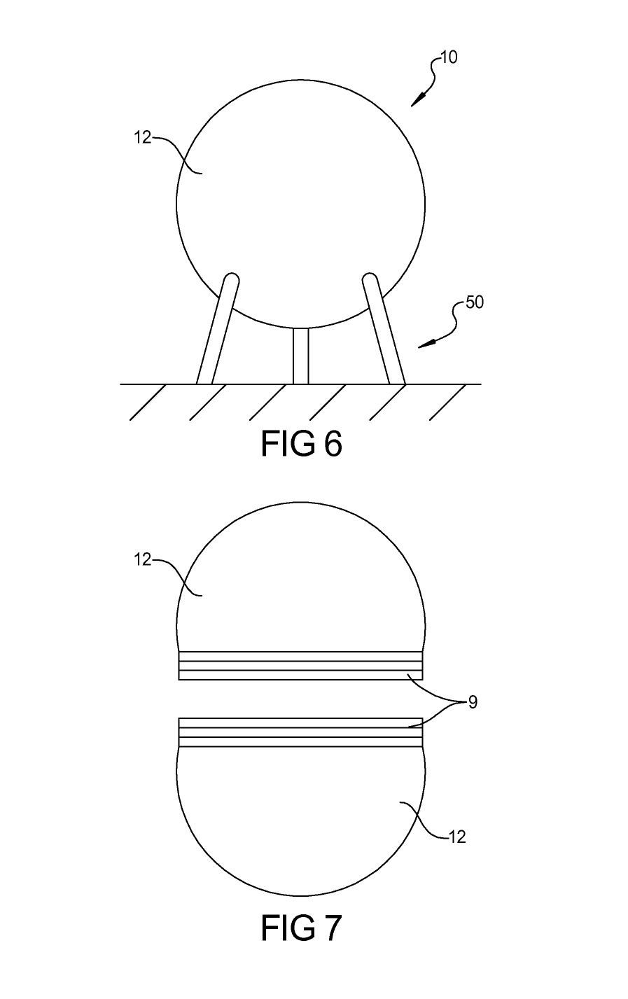

As shown in FIG. 6, the reactor 10 can also be provided with means for isolating 50 the reactor 10 from external vibration. The means for isolating 50 can comprise a foundation such as a base or plurality of feet which can be supported by springs, shock absorbers, shock-absorbing elastomers such as the type sold under the trademark Sorbothane®, any suitable type of visco-elastic material, or the like.

It is to be appreciated by one having ordinary skill in the art that the present invention is scalable in size for various applications, as needed. For instance, the present invention can be used to provide electricity in: small-scale applications, such as laptop computers or small household appliances for which portability is desired; medium-scale applications, such as for electric cars or for household-wide electrical production; or large-scale applications, such as providing electricity to entire buildings, or as a power plant for entire cities. Small capacity fusion reactors, such as used with laptops, can comprise a core 12 formed from two half spheres sandwiched between two halves of an aluminum block. The aluminum block can include heatsink fins cast into the aluminum block for additional free-air cooling.

The frequency generator 18 can comprise a traveling-wave tube when the present invention is used with small-scale applications. The traveling-wave tube, or TWT, is an electronic device used to amplify radio frequency signals to high power. A TWT can produce frequencies in the range of 300 MHz to 50 GHz. A TWT is an elongated vacuum tube with a heated cathode that emits electrons at one end. A magnetic containment field around the tube focuses the electrons into a beam, which then passes down the middle of a wire helix that stretches from the RF input to the RF output, the electronic beam finally striking a collector at the other end. A directional coupler, which can be either a waveguide 34 or an electromagnetic coil, is fed with the low-powered radio signal that is to be amplified, and is positioned near the emitter, and which induces a current into the helix. The helix acts as a delay line in which the RF signal travels at approximately the same speed along the tube as the electron beam. The electrons are “bunched” together as the electromagnetic field interacts with the electron beam due to the current in the helix. The electromagnetic field then induces more current back into the helix.

In this embodiment, a solid state having an RFI source providing a frequency in the range of about 2.4 GHz to about 5.8 GHz or higher is provided by the TWT. The TWT emits the frequency into the interior chamber 14 which is filled with the fuel 16. The mass of the fuel 16 in this embodiment may be as small as 0.01 gram to provide electricity to a battery such as found in a laptop computer, although it may be larger.

When the present invention is used for medium-scale applications, the frequency generator 18 preferably comprises a magnetron.

A magnetron is a high-powered vacuum tube that generates non-coherent microwaves. A magnetron consists of a hot filament, or cathode, which is kept at or pulsed to a high negative potential by a high-voltage, direct-current power supply. The cathode is built into the center of an evacuated, lobed, circular chamber. A magnetic field parallel to the filament is imposed by a permanent magnet. The magnetic field causes the electrons, which are attracted to the positively charged outer portion of the chamber, to spiral outward in a circular path rather than moving directly to the positive anode. Spaced around the rim of the chamber are cylindrical cavities. The cavities are open along their length and connect the common chamber space. As electrons sweep past these openings they induce a resonant, high-frequency radio field in the chamber, which in turn causes the electrons to bunch into groups. A portion of this field is extracted with a short antenna that is connected to the waveguide 34.

Medium-sized applications require an output from the frequency generator 18 in the range of about 500 Watts to about 1500 Watts. A very narrow bandwidth RF output from the frequency generator 18 is emitted directly into the interior chamber 14 via the waveguide 34. The frequency generator 18 and waveguide 34 are hermetically sealed to the core 12. In this embodiment, the fuel 16 is at a pressure of about 2,000 psi or higher, and the volume of the fuel 16 can be approximately 1 liter, although it may be more or less depending upon the application and the size of the core 12. The pressure can preferably be about 2,500 psi.

The reactor 10 for medium-sized applications, such as a portable generator and a generator equipped to provide electricity to an entire home, can provide an output of about 1500 Watts to about 50,000 Watts of continuous output.

When the present invention is used for large-scale applications, the frequency generator 18 can comprise a gyrotron or a klystron.

A gyrotron is a high-powered vacuum tube which emits millimeter-wave beams by bunching electrons with cyclotron motion in a strong magnetic field. Output frequencies range from about 20 GHz to about 250 GHz, and gyrotrons can be designed for pulsed or continuous operation. A gyrotron is a type of free electron MASER (Microwave Amplification by Stimulated Emission of Radiation). It has high power at millimeter wavelengths because its dimensions can be much larger than the wavelength, unlike conventional vacuum tubes, and it is not dependent on material properties, as are conventional MASER's. Gyrotrons are often used to heat plasmas.

A klystron is a specialized linear-beam vacuum tube. Klystrons are used as amplifiers at microwave and radio frequencies to produce both low-power reference signals for superheterodyne radar receivers and to produce high-power carrier waves for communications. They are the driving force for modern particle accelerators. Klystron amplifiers have the advantage over the magnetron of coherently amplifying a reference signal so its output may be precisely controlled in amplitude, frequency, and phase. Klystrons have an output in the range of 50 megawatts at frequencies nearing 3 GHz. Many klystrons have a waveguide for coupling microwave energy into and out of the device, although it is also quite common for lower power and lower frequency klystrons to use coaxial couplings instead. In some cases a coupling probe is used to couple the microwave energy from a klystron into a separate external waveguide. Klystrons operate by amplifying RF signals by converting the kinetic energy in a DC electron beam into radio frequency power. A beam of electrons is produced by a thermionic cathode (a heated pellet of low work function material), and accelerated by high voltage electrodes (typically in the tens of kilovolts). This beam is then passed through an input chamber. RF energy is fed into the input chamber at a voltage or amplitude which is at, or near, the natural frequency of the fuel 16 to excite the molecules of the fuel 16. The electric field causes the electrons to bunch because electrons which pass through during an opposing electric field are accelerated while later electrons are slowed; thereby causing the previously continuous electron beam to form bunches at the input frequency. The RF current carried by the beam will produce an RF magnetic field, and this will in turn excite a voltage across the gap of subsequent resident activities. In the output chamber, the developed RF energy is coupled out. The spent electron beam, with reduced energy, is then captured in a collector.

Large-sized applications require an output from the frequency generator 18 in the range of about 1500 Watts or greater. The frequency generator 18 can emit the RF output directly into the interior chamber 14 via the waveguide 34. The frequency generator 18 can also be directly attached to the core 12 to directly emit the RF output into the core 12. The frequency generator 18 and waveguide 34 are hermetically sealed to the core 12. The interior chamber 14 of the core 12 is filled with the fuel 16 pressurized to about 2,000 psi or higher. The volume of the fuel 16 in this embodiment may be as small as 1 liter, although it may be sufficiently larger so that the fusion reactor can provide adequate electricity for an entire metropolis, an industrial center or manufacturing plant, a naval warship, a submarine, and so forth.

The reactor 10 for large-sized applications, such as for powering industrial buildings, naval or space vessels, or to provide power to the national power grid, would provide an output of about 1500 megaWatts or more, depending upon the volume of the interior chamber 14.

In order to ensure that the reactor 10 operates at a proper temperature for peak performance and efficiency, other means for cooling can be provided as well. The means for cooling can be embodied by various structural elements. For instance, in small-scale applications such as in a laptop computer, the means for cooling can comprise the reactor 10—including the core 12 and frequency generator 18—being surrounded and embedded within an outer shell, such as a metal “strong box,” to maintain both the integrity of the reactor 10 and to act as a heatsink. The means for cooling in such small-scale applications can comprise a cast metal “clamshell” type box having a top and a bottom half which are secured together by fasteners, such as screws. A gasket made from a heat conductive material can be secured between the halves of the box. In such an application, the means for cooling can be formed from metals having excellent thermal conductivity properties, such as molybdenum, molybdenum copper, tungsten, tungsten copper, and the like.

In medium-scale applications, the means for cooling can comprise heatsink fins attached directly to the exterior 24 of the core 12. The fins are formed from a material having a high thermal conductivity, such as metal. Preferably the metal used is aluminum, copper, or the like. The fins are affixed to the core 12 by a method which is conducive to the transfer of heat from the core 12 to the means for cooling, such as welding (when appropriate according to material types), fasteners (along with thermally conductive gaskets or grease), and so forth. An automated temperature control system (not shown) can be provided to operate the means for cooling to regulate the temperature of the core 12. The temperature control system can include at least one temperature sensor (e.g., a thermistor, thermocouple, etc.), means for effectuating the flow of a fluid over the fins (e.g., a fan), and a controller (e.g., processor, CPU, etc.) for turning the means for effectuating flow on and off to regulate the temperature of the core 12 within a preferable range.

In large-scale applications, the means for cooling can comprise the core 12 having a system of passageways through which a coolant may flow, such as found in the cooling system for an engine block. A coolant pump for circulating the coolant and means for cooling the coolant can also be provided. An automated system, such as described above, can be provided to ensure that the reactor 10 operates within a desired temperature range.

It is to be appreciated by one having ordinary skill in the art that by varying the amplitude of the frequency emitted into the chamber 14, the flow of electricity can correspondingly be adjusted, stopped entirely, or set to a low amount such as to provide a trickle charge to produce MeV directly off of the plurality of electron receivers 40. It is anticipated that when the frequency generator 18 produces a frequency in the range of about 2.4 GHz, the resonated fuel 16 will develop an inertia against itself at a very high rate, higher than 1 trillion times per second due to the unique properties of the spherical core 12. This high rate of resonance will maximize density of the fuel 16 over time, rather than a laser THz AC sine wave or lesser microwave GHz frequency that will not achieve as high density over time, which would prevent any fusion reactions from occurring, or at best operate with reduced efficiency of the reactor. A higher frequency standing wave resonance harmonic develops from the unique wave propagation and interaction phenomena of the spherical chamber 14. A frequency of about 2.4 GHz emitted by the frequency generator 18 will effectuate lightning and arcing across the ends of the plurality of electron receivers 40 (e.g., the ends of frayed out wires protruding into the interior chamber 14). The amplitude of the signal is adjusted accordingly for the volume of the interior chamber 14. The geometry of the interior chamber 14 creates a dominant radio frequency standing wave resonance to develop within the fuel 16 due to the unique wave propagation and interaction properties of the chamber 14 when driven with sufficient amplitude in the radio frequency domain.

One having ordinary skill in the art will also understand that the cubic volume of the spherical chamber 14 should be properly mated to the actual amplitude, or wattage, of the signal produced by the frequency generator 18. The objective is to produce a high rate of vibration (or resonance) within the fuel 16 in order to produce the heat necessary to surpass Lawson's criterion.

Optionally, the fusion reactor can include at least two frequency generators which are preferably identical and synced to provide simultaneous RF outputs. The synced RF outputs are synchronized via a Phase-Locked-Loop (PLL) driving circuit which preferably synchronizes the simultaneous RF outputs in terms of frequency, amplitude, and phase. The at least two frequency generators emit through identical apertures and waveguides and/or traveling wave tubes into the interior chamber of the core. The at least two frequency generators are secured and oriented to the core such that they aim their RF output to intersect at a focal point inside the interior chamber. The focal point is preferably located near the middle of the interior chamber.

When the lining 26 is provided, lithium (e.g., lithium 3, 5, or 7) can be selected as a possible material for the inner lining 26 because it reacts with certain gas fuels, such as Tritium, to create more Tritium, thereby allowing a fuel 16 fuel mixture to last longer in the reaction before needing to be evacuated and replaced with a fresh, pure Deuterium/Tritium mixture. Lithium also traps Alpha particles and high energy neutrons.

The reactor 10 can also optionally include means for resonating which are placed or affixed within the interior chamber 14. The means for resonating can comprise glass, metal, crystal, ceramic, composite, or any suitable shape like a horn, a flare, a cylinder, a bell, etc. which will effectuate the RF resonance such as “ringing” and lightning production caused by the RF energy striking the means for resonating causing it to ring forming lightning and arcing and flame. The means for resonating can be wrapped, coiled, embedded, or otherwise in close contact with high-temperature resistant wire, metal ribbon, vapor-deposited metal onto the means for resonating to facilitate or affect the RF resonances or resonances within or upon the metal(s) that result in the lightning/flame/sparks/high temperature being created. The metal can comprise, but is not limited to, tungsten, nickel chrome, iridium, and so forth.

Referring back to the present invention in general, the resulting higher frequency harmonic wave resonance will effectuate fusion in tandem with the small, localized lightening that will occur around and about the ends of the frayed wires from the plurality of electron receivers. Millions of atomic-level fusion reactions will continuously occur within the plasma surrounding the plurality of the electron receivers 40 when the microwave driving frequency is admitted into the interior chamber 14, either pulsed at a measured rate or continuously, depending on the reactor output required.

It is to be appreciated by one having ordinary skill in the art that the lightning and arcing inside the core 12 will rapidly produce a hot plasma having the high surface tension and high surface temperatures required to overcome the Coulomb forces and fuse nuclei together. At that same time, providing an electrical pathway for the electrons to charge a battery, MeV inverter, supercapacitor, or similar device. A diode arrangement can be provided to prevent reverse flow of electrical discharge. The plurality of electron receivers 40 can be frayed out like carpeting, or in the case of very small-sized spheres for batteries, just a small number of wire strands can protrude into the interior of the core 12. The plurality of electron receivers 40 can run through the wall of the core 12 using high-pressure gaskets and seals to contain the gasses under pressure and to collect the resulting protons and electrons that are produced during the nuclear fusion process.

The resulting higher frequency harmonic wave resonance will effectuate fusion in tandem with the small localized arcing, or lightning, which will occur around and about the ends of the electron receivers 40. Millions of atomic level fusion reactions will continuously occur within the plasma surrounding the electron receivers 40, as long as the microwave driving frequency from the frequency generator 18 is submitted into the interior chamber 14 (either pulsed at a measured rate or continuous), depending on the reactor output required.

When the core 12 is formed from a magnetic material, the invention provides a magnetic core 12 filled with a radio frequency to effectuate a standing wave harmonic resonance for both magnetic confinement and inertial confinement. Inertial confinement can be achieved by a standing wave resonance pattern which is caused by powerful microwave emission which results from the properties of a spherical enclosure and the loose excitable hemispherical resonance's when struck by high energy RF.

The microwave sphere design will effectuate cold fusion with the wired “lightning” version pulsed by a high frequency microwave source in the GHz-THz region, or hot fusion in the non-wired version which is not pulsed, but over driven by a powerful microwave source which is run constantly to heat water to run a steam turbine which is connected to a common electrical fusion reactor in use today. The generator can be driven by any suitable radio frequency up to and including 1 THz, including the range of 2.4-2.6 GHz, which is the most common range for microwave oven generators.

Although various embodiments of the invention have been disclosed for illustrative purposes, it is understood that one skilled in the art can make variations and modifications without departing from the spirit of the invention.

What is claimed is:

1. A fusion reactor for generating electricity comprising:
(a) a core having an interior chamber, the interior chamber having a top portion and a bottom portion, the core being filled with a volume of an inert gas;
(b) a frequency generator secured to the core and configured to input a signal into the interior chamber to resonate the gas at a high frequency;
(c) a pair of electrical conductors, a first electrical conductor from the pair of electrical conductors connected to the top portion, and a second electrical conductor from the pair of electrical conductors connected to the bottom portion, the pair of electrical conductors provided to conduct the flow of electricity away from the core.

2. The fusion reactor of claim 1 wherein the fuel is an advanced fuel.

3. The fusion reactor of claim 2 wherein the fuel is Helium-3.

4. The fusion reactor of claim 3 wherein the core comprises beryllium.

5. The fusion reactor of claim 1 wherein the core includes a lining.

6. The fusion reactor of claim 5 wherein the lining comprises a neutron-absorbing material.

7. The fusion reactor of claim 1 including a plurality of conductive electron receivers connected to each of the first and second electrical conductors, the plurality of electron receivers extending at least partially into the interior chamber.

8. The fusion reactor of claim 7 wherein the plurality of electron receivers includes a plurality of ends which are conductively exposed.

9. The fusion reactor of claim 5 wherein the lining comprises beryllium.

10. The fusion reactor of claim 5 wherein the lining comprises carbon-fiber.

11. A fusion reactor for generating electricity comprising:
(a) a core having an interior chamber, the interior chamber having a top portion and a bottom portion, the core comprising beryllium and being filled with a volume of a fuel;
(b) a frequency generator secured to the core and configured to input a signal into the interior chamber to resonate the fuel at a high frequency;
(c) a pair of electrical conductors, a first electrical conductor from the pair of electrical conductors connected to the top portion, and a second electrical conductor from the pair of electrical conductors connected to the bottom portion, the pair of electrical conductors provided to conduct the flow of electricity away from the core.

12. The fusion reactor of claim 11 including a plurality of conductive electron receivers connected to each of the first and second electrical conductors, the plurality of electron receivers extending at least partially into the interior chamber.

13. The fusion reactor of claim 12 wherein the plurality of electron receivers includes a plurality of ends which are conductively exposed.

14. The fusion reactor of claim 11 wherein the fuel is an inert gas.

15. The fusion reactor of claim 14 wherein the fuel is Helium-3.

16. The fusion reactor of claim 11 wherein the fuel is an advanced fuel.

17. The fusion reactor of claim 16 wherein the fuel is Helium-3.

18. The fusion reactor of claim 11 wherein the core includes a lining.

19. The fusion reactor of claim 18 wherein the lining comprises a neutron-absorbing material.

20. The fusion reactor of claim 11 wherein the signal is pulsed on and off.
